(19) United States
(12) Patent Application Publication
(10) Pub. No.: US 2009/0234701 A1
(43) Pub. Date: Sep. 17, 2009

(54) Method for assessing business transformations having an information technology component

(75) Inventor: Sharon Beth Amdall, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 12/073,979

(22) Filed: Mar. 12, 2008

(51) Int. Cl. G06Q 10/00

(52) U.S. Cl. 705/9; 705/7; 705/10; 705/11; 705/8

(57) ABSTRACT

A method for assessing a business transformation is disclosed. The method includes identifying a marketplace need for the business transformation and determining a business process to meet the marketplace need. The method also includes determining a plurality of requirements to execute the business process and identifying one or more information technology applications to meet the plurality of requirements. The method further includes determining an information technology infrastructure for running the one or more information technology applications and determining an extent of use of the business process by information technology users and customers. The method also includes determining business value created by the business process and evaluating the determinations using a plurality of computer data forms.

### TECHNICAL FIELD

The present disclosure relates generally to a system and method for assessing business transformations and, more particularly, to a system and method for assessing business transformations having an information technology component.

### BACKGROUND

In today's rapidly changing marketplace, enterprises must constantly adapt to changing market conditions to remain competitive. Information technology (IT) is a prevalent and pervasive aspect of modern business. A typical enterprise might use a variety of different IT systems for performing tasks such as, for example, engineering design and e-mail communication. IT provides one means by which enterprises, such as businesses, can engage in business transformations to create business value and compete more effectively in the marketplace. Therefore, successful business transformation must include integrated IT components that focus, like the rest of the components of the business transformation, on creating business value.

A disconnect exists, however, between business transformations having IT components and the creation of business value. That is, IT investments fail to create business value at an unsatisfactorily high rate. Some managers attribute this high rate of failure to a disconnect between an IT transformation and the goals of a business. Typical ill-conceived IT projects begin with managers discovering a newly-available piece of technology on the market. Managers direct their IT departments to acquire and implement the new technology into the business, omitting a rigorous analysis to determine whether the technology actually creates business value.

One attempt at ensuring that changes in IT systems of a business create business value is described by U.S. Patent Application Publication 2006/0143219 A1 (the '219 publication) by Smith et al., published on Jun. 29, 2006. The '219 publication discloses a method for determining and implementing business changes. The '219 publication defines a set of work product comprising a group of closely related transformation activities that produce a client-recognizable product for each element. Selectable components are presented to the user in a graphical user interface. The '219 publication discloses that successive selection of components presents greater detail to the user about the corresponding component.

Although the method of the '219 publication may be adequate for allowing an individual user to design aspects of a business transformation, it fails to provide a method for making decisions at an executive level concerning a business transformation. The '219 publication fails to provide a method for senior managers to evaluate whether marketplace needs and a business process drive and establish requirements and definitions of IT applications. The '219 publication also fails to provide a method for senior managers to evaluate whether IT applications enable and deliver business value through user and/or customer use of the IT applications.

The system and method of the present disclosure is directed towards overcoming one or more of the constraints set forth above.

### SUMMARY OF THE DISCLOSURE

In one aspect, the present disclosure is directed to a method for assessing a business transformation. The method includes identifying a marketplace need for the business transformation and determining a business process to meet the marketplace need. The method also includes determining a plurality of requirements to execute the business process and identifying one or more information technology applications to meet the plurality of requirements. The method further includes determining an information technology infrastructure for running the one or more information technology applications and determining an extent of use of the business process by information technology users and customers. The method also includes determining business value created by the business process and evaluating the determinations using a plurality of computer data forms.

In another aspect, the present disclosure is directed toward a system for assessing a business transformation containing an information technology component. The system includes an input device for receiving input associated with an assessment and an output device for providing assessment data to a user. The system also includes a storage device. The storage device is configured to store a score relating to identifying a marketplace need and to store a score relating to determining a business process to meet the marketplace need. The processor is also configured to store a score relating to determining a plurality of requirements to execute the business process and to store a score relating to identifying one or more information technology applications to meet the plurality of requirements. The processor is further configured to store a score relating to determining an information technology infrastructure for running the one or more information technology applications and to store a score relating to determining an extent of use of the business process by information technology users and customers. The processor is also configured to store a score relating to determining business value created by the business process.

### BRIEF DESCRIPTION OF THE DRAWINGS

FIG. 1 is a block illustration of an exemplary disclosed processing system;

FIG. 2 is a block illustration of an exemplary disclosed assessment system;

FIG. 3 illustrates a detail of the block illustration of FIG. 1;

FIG. 4 illustrates a detail of the block illustration of FIG. 1;

FIG. 5 illustrates a detail of the block illustration of FIG. 1;

FIG. 6 illustrates a detail of the block illustration of FIG. 1;

FIG. 7 illustrates a detail of the block illustration of FIG. 1;

FIG. 8 illustrates a detail of the block illustration of FIG. 1; and

FIG. 9 illustrates a detail of the block illustration of FIG. 1.

### DETAILED DESCRIPTION

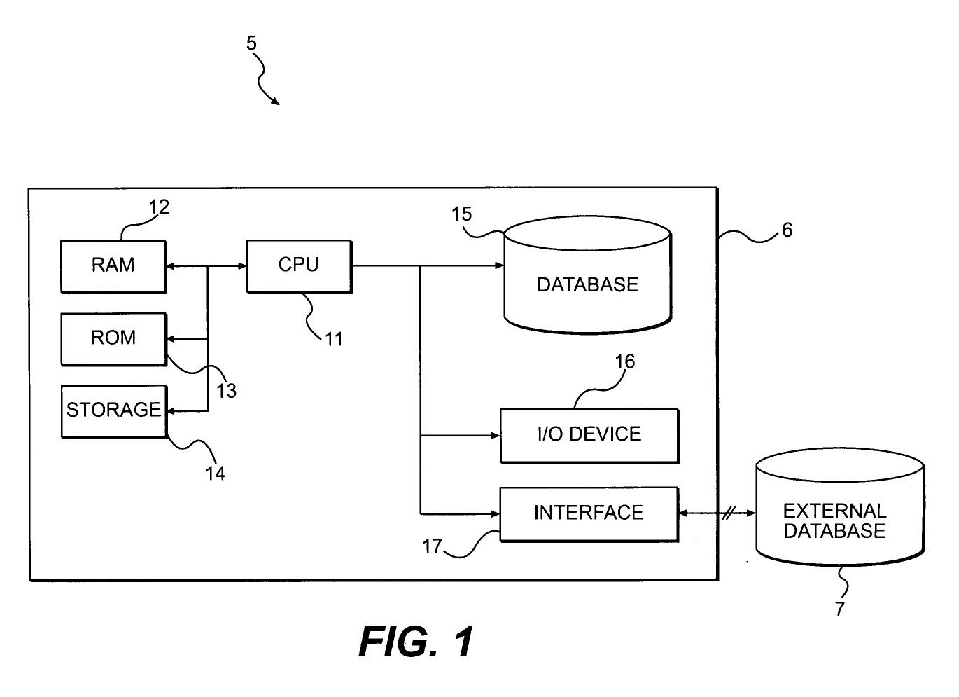

FIG. 1 provides a block diagram illustrating an exemplary environment 5 for automated processing. Environment 5 may include a system 6 and an external database 7. System 6 may be, for example, a general purpose personal computer or a server. Although illustrated as a single system 6, a plurality of systems 6 may connect to other systems, to a centralized server, or to a plurality of distributed servers using, for example, wired or wireless communication.

System 6 may include any type of processor-based system on which processes and methods consistent with the disclosed embodiments may be implemented. For example, as illustrated in FIG. 1, system 6 may include one or more hardware and/or software components configured to execute software programs. System 6 may include one or more hardware components such as a central processing unit (CPU) 11, a random access memory (RAM) module 12, a read-only memory (ROM) module 13, a storage 14, a database 15, one or more input/output (I/O) devices 16, and an interface 17. System 6 may include one or more software components such as a computer-readable medium including computer-executable instructions for performing methods consistent with certain disclosed embodiments. One or more of the hardware components listed above may be implemented using software. For example, storage 14 may include a software partition associated with one or more other hardware components of system 6. System 6 may include additional, fewer, and/or different components than those listed above, as the components listed above are exemplary only and not intended to be limiting.

CPU 11 may include one or more processors, each configured to execute instructions and process data to perform one or more functions associated with system 6. As illustrated in FIG. 1, CPU 11 may be communicatively coupled to RAM 12, ROM 13, storage 14, database 15, I/O devices 16, and interface 17. CPU 11 may execute sequences of computer program instructions to perform various processes, which will be described in detail below. The computer program instructions may be loaded into RAM 12 for execution by CPU 11.

RAM 12 and ROM 13 may each include one or more devices for storing information associated with an operation of system 6 and CPU 11. RAM 12 may include a memory device for storing data associated with one or more operations of CPU 11. For example, ROM 13 may load instructions into RAM 12 for execution by CPU 11. ROM 13 may include a memory device configured to access and store information associated with system 6.

Storage 14 may include any type of mass storage device configured to store information that CPU 11 may need to perform processes consistent with the disclosed embodiments. For example, storage 14 may include one or more magnetic and/or optical disk devices, such as hard drives, CD-ROMs, DVD-ROMs, or any other type of mass media device.

Database 15 may include one or more software and/or hardware components that cooperate to store, organize, sort, filter, and/or arrange data used by system 6 and CPU 11. Database 15 may store data collected by system 6.

I/O device 16 may include one or more components configured to communicate information to a user associated with system 6. For example, I/O devices may include a console with an integrated keyboard and mouse to allow a user to input parameters associated with system 6. I/O device 16 may also include a display, such as a monitor, including a graphical user interface (GUI) for outputting information. I/O devices 16 may also include peripheral devices such as, for example, a printer for printing information and reports associated with system 6, a user-accessible disk drive (e.g., a USB port, a floppy, CD-ROM, or DVD-ROM drive, etc.) to allow a user to input data stored on a portable media device, a microphone, a speaker system, or any other suitable type of interface device.

The results of received data may be provided as an output from system 6 to I/O device 16 for printed display, viewing, and/or further communication to other system devices. Output from system 6 may also be provided to database 15 and to external database 7.

Interface 17 may include one or more components configured to transmit and receive data via a communication network, such as the Internet, a local area network, a workstation peer-to-peer network, a direct link network, a wireless network, or any other suitable communication platform. In this manner, system 6 may communicate with other network devices, such as external database 7, through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 17 may include one or more modulators, demodulators, multiplexers, demultiplexers, network communication devices, wireless devices, antennas, modems, and any other type of device configured to enable data communication via a communication network.

Those skilled in the art will appreciate that all or part of systems and methods consistent with the present disclosure may be stored on or read from other computer-readable media. Environment 5 may include a computer-readable medium having stored thereon machine executable instructions for performing, among other things, the methods disclosed herein. Exemplary computer readable media may include secondary storage devices, such as hard disks, floppy disks, and CD-ROM; or other forms of computer-readable memory, such as read-only memory (ROM) 13 or random-access memory (RAM) 12. Such computer-readable media may be embodied by one or more components of environment 5, such as CPU 11, storage 14, database 15, and external database 7.

Furthermore, one skilled in the art will also realize that the processes illustrated in this description may be implemented in a variety of ways and include other modules, programs, applications, scripts, processes, threads, or code sections that may all functionally interrelate with each other to provide the functionality described above for each module, script, and daemon. For example, these programs, modules, etc., may be implemented using commercially available software tools, using custom object-oriented code written in the C++ programming language, using applets written in the Java programming language, or may be implemented with discrete electrical components or as one or more hardwired application specific integrated circuits (ASICs) or field-programmable gate arrays (FPGAs) that are custom-designed for this purpose.

System 6 may include a software program for receiving data entry into one or more data forms. These forms may be used to record data such as, for example, assessment criteria data. Users of system 6 may enter data into I/O Device 16. Data may be stored on database 15 or external database 7. Data may be recorded on computerized data forms using computer system 6.

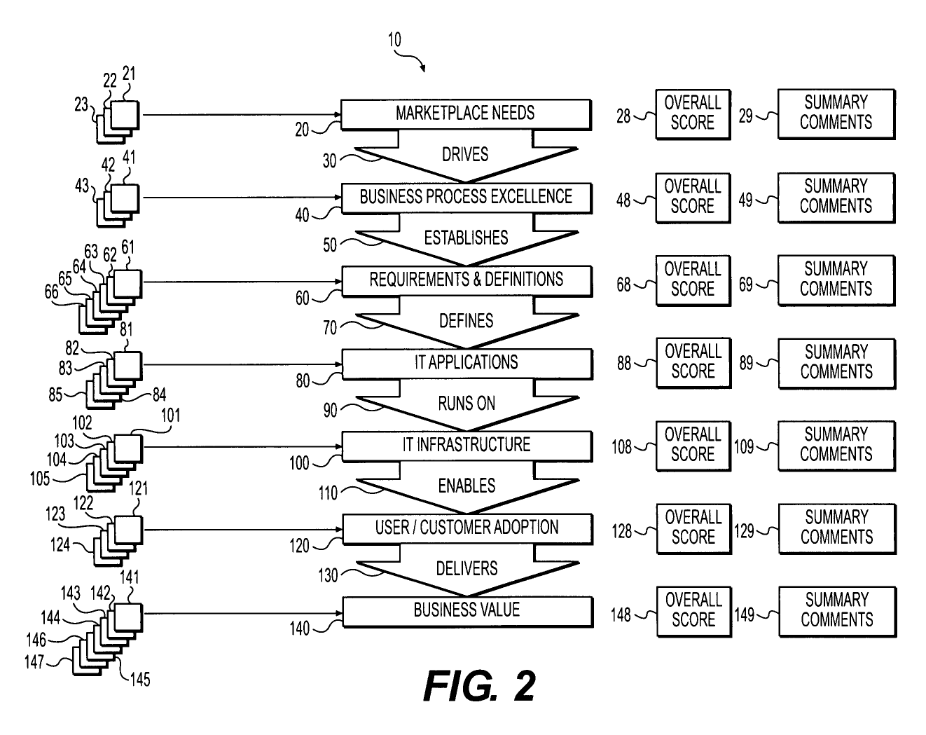

An exemplary embodiment of an assessment system 10 is shown in FIG. 2. Assessment system 10 may be an assessment tool for use by an enterprise such as, for example, a business. Assessment system 10 may apply to major initiatives of a business that contain an IT component. Assessment system 10 may be time-neutral and applicable to past, present, and future business transformations. Assessment system 10 may include data that may be processed on system 6 as described above.

Assessment system 10 may be used by executive officers or senior managers of an enterprise to assess a business transformation that includes an IT component. For example, the chief information officer (CIO) of a business may use assessment system 10 in evaluating whether a business transformation that includes an IT component should be made. Assessment system 10 may be broad enough in scope to allow senior managers to evaluate a business transformation having an IT component in the context of its effects on the entire organization (i.e., seeing the “big picture”). The business transformation may be any type contemplated by a business. For purposes of illustration, an example of a business transformation including an IT component may be changing the business process, including new software, for sales staff of an enterprise to use in assisting customers who are inquiring about products (i.e., improving the order-to-delivery business process of an enterprise). Criteria of assessment system 10 may be designed for large projects affecting large portions of an entire enterprise. Assessment system 10 may include broad assessment criteria, without numerous details and complex weighting calculations. Assessment system 10 may include senior leaders using business judgment to “step back” and evaluate the broad assessment criteria describing a large project. Assessment criteria of assessment system 10 may be formulated as desired states of a business transformation to be confirmed or denied by providing a scoring system whereby users enter an assessment score indicative of how well an actual state of the business transformation process correlates with the desired state.

Each assessment criterion, though spanning an entire business transformation, may be included once in assessment system 10. Including each assessment criterion once may help to reduce the complexity of the evaluation and help senior managers to see the “big picture” to evaluate the business transformation as a whole. Each assessment criterion may include a few (i.e., approximately seven or less) supporting criteria. Therefore, a number of supporting criteria may support each assessment criterion, as more fully described below. The supporting criteria may further specify and define a desired state of the supported assessment criteria. Each supporting criteria may be assigned a score to be presented to a senior manager such as, for example, a CIO. Based on the scores of the supporting criteria and business judgment, the senior manager may assign each assessment criterion a score, as more fully described below.

Each supporting criterion may also include brief comments. The brief comments may explain specialized items while avoiding excessive detail. Specialized items may include, for example, technical issues involving specific expertise and engineering judgment. The brief comments associated with the supporting criteria may help relate specialized items in terms that an executive will recognize and understand (e.g., identifying the crux of a detailed technical issue). The brief comments may also put specialized items into context with the organization as a whole, so the executive may determine how the organization as a whole may be affected. Based on the comments of the supporting criteria, the senior manager may make summary comments for each assessment criterion.

As shown in one exemplary embodiment of assessment system 10 in FIG. 2, assessment system 10 may include seven assessment criteria: an assessment criterion 20 (Marketplace Needs), an assessment criterion 40 (Business Process Excellence), an assessment criterion 60 (Requirements & Definitions), an assessment criterion 80 (IT Applications), an assessment criterion 100 (IT Infrastructure), an assessment criterion 120 (User/Customer Adoption), and an assessment criterion 140 (Business Value). The assessment criteria may be logically joined by six links: a link 30 (Drives) linking assessment criteria 20 and 40, a link 50 (Establishes) linking assessment criteria 40 and 60, a link 70 (Defines) linking assessment criteria 60 and 80, a link 90 (Runs On) linking assessment criteria 80 and 100, a link 110 (Enables) linking assessment criteria 100 and 120, and a link 130 (Delivers) linking assessment criteria 120 and 140. The links may logically join the assessment criteria to form a logical flow for users of assessment system 10 to follow in evaluating business transformations having an IT component.

Some of the assessment criteria may focus on purely business (i.e., non-IT) components of a business transformation, while other criteria may focus on IT components of a business transformation. For example, assessment criterion 20 (Marketplace Needs), assessment criterion 40 (Business Process Excellence), assessment criterion 120 (User/Customer Adoption), and assessment criterion 140 (Business Value) may each focus on non-IT components of a business transformation. Assessment criterion 60 (Requirements & Definitions) may focus on both IT and non-IT components of a business transformation. Assessment criterion 80 (IT Applications) and assessment criterion 100 (IT Infrastructure) may focus on IT components of a business transformation.

Assessment system 10 may include assessment criterion 20 (Marketplace Needs). Assessment criterion 20 may focus on identifying a connection between a contemplated business transformation and external marketplace needs. Assessment criterion 20 may include identifying a marketplace need for the business transformation by determining if there is an indication of business opportunity in the marketplace. The nature of customer businesses and the business value drivers that motivate customers may be considered. Users of assessment system 10 may also evaluate and document competitors and industry trends and realities in determining assessment criterion 20 (Marketplace Needs).

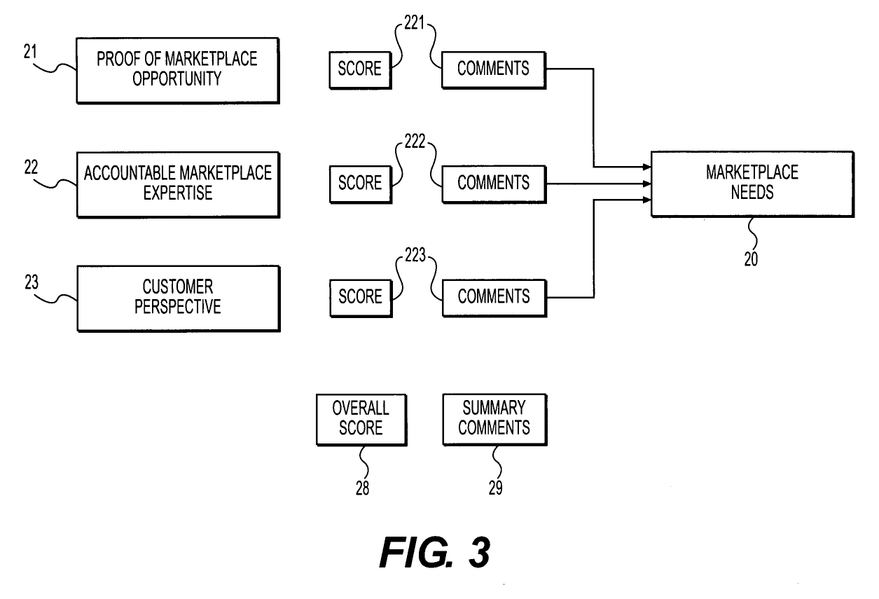

Assessment criteria 20 may include supporting criteria 21, 22, and 23, as shown in FIG. 3. Supporting criterion 21 may focus on identifying indications of marketplace opportunity. In evaluating assessment criterion 21, users may document indications of marketplace opportunity, both current and future. In certain situations, marketplace opportunities may be regional and, therefore, users may categorize indications of marketplace opportunity by region. Supporting criterion 22 may focus on applying accountable marketplace expertise, where experts within the enterprise who work in areas affected by the transformation may be involved. For example, a member of an enterprise who is considered to be an expert in the marketplace needs that are being considered may make a subjective assessment of those needs. Supporting criterion 23 may focus on end customers' values and perspectives. Users may research end customers' value drivers (i.e., what motivates the customers to make decisions in the marketplace) to ensure that the contemplated business transformation recognizes those drivers.

Using the data entry forms of computer system 6, users may assign supporting scores and comments 221, 222, and 223 to supporting criteria 21, 22, and 23, respectively, as shown in FIG. 3. Supporting scores and comments 221, 222, and 223 may be based on business judgment and may be broadly focused, without excessive detail. Scores may be based on any number convention such as, for example, a “1 to 10” convention with “1” indicating a poor rating and “10” indicating an excellent rating. Users may also prepare summary comments 29 by pulling key points from supporting scores and comments 221, 222, and 223. Users may present supporting scores and comments 221, 222, and 223 and summary comments 29 to a senior manager such as, for example, the CIO. The scores may evaluate how well each supporting criterion was performed. The CIO, using business judgment, supporting scores and comments 221, 222, and 223, and summary comments 29, may determine an overall score 28 for how well assessment criterion 20 (Marketplace Needs) was performed by the enterprise.

Users of assessment system 10 may use the Marketplace Needs identified and evaluated in assessment criterion 20 to help determine the Business Process Excellence of assessment criterion 40. Users may identify how assessment criterion 40 (Business Process Excellence) is driven (link 30) by assessment criterion 20 (Marketplace Needs). Users may determine link 30 by determining the business processes that meet marketplace needs by delivering functionality at the lowest cost. Users must determine what new or altered business process may give the enterprise a competitive edge in the marketplace. Assessment criterion 40 may also involve consulting with IT experts to incorporate commercially available software and software services that are relevant to the new or altered business process.

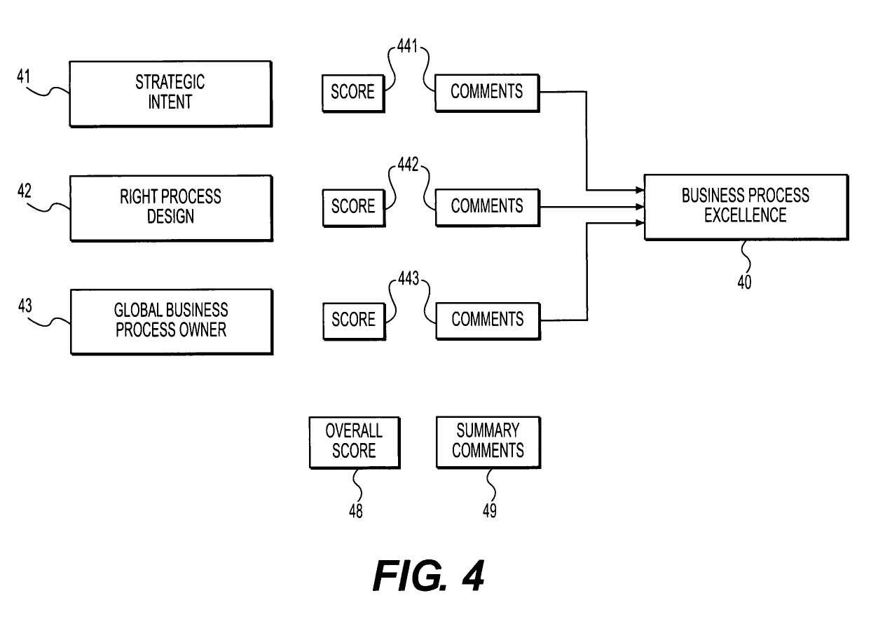

Assessment criterion 40 (Business Process Excellence) may include supporting criteria 41, 42, and 43, as shown in FIG. 4. Supporting criterion 41 may focus on documenting the strategic intent for the business process to deliver either competitive differentiation (i.e., better, faster, and more efficient than competitors) and/or providing the lowest cost in the marketplace, where delivering competitive differentiation and providing the lowest cost in the marketplace may increase the sales and the market share of the enterprise. Supporting criterion 42 may focus on selecting an appropriate business process design. Any differences between the appropriate business design and commercially-available business processes may be clearly linked to creating business value. Supporting criterion 43 may focus on identifying an individual within the enterprise to take ownership of the business process and deliver business results.

Using the data entry forms of computer system 6, users may assign supporting scores and comments 441, 442, and 443 to supporting criteria 41, 42, and 43, respectively, as shown in FIG. 4. Supporting scores and comments 441, 442, and 443 may be based on business judgment and be broadly focused, without excessive detail. Users may also prepare summary comments 49 by pulling key points from supporting scores and comments 441, 442, and 443. Users may present supporting scores and comments 441, 442, and 443 and summary comments 49 to the CIO. The scores may evaluate how well each supporting criterion was performed. The CIO, using business judgment, supporting scores and comments 441, 442, and 443, and summary comments 49, may determine an overall score 48 for how well assessment criterion 40 was performed by the enterprise.

Users of assessment system 10 may use the Business Process Excellence identified and evaluated in assessment criterion 40 to help determine the Requirements & Definitions of assessment criterion 60. Users may identify how assessment criterion 60 (Requirements & Definitions) is established (link 50) by assessment criterion 40 (Business Process Excellence). Users may determine link 50 by identifying what the enterprise requires to facilitate the business process. Assessment criterion 60 may focus on determining a plurality of requirements for establishing the business process. Users may focus on developing a comprehensive business and project plan, including all impacted organizations and functions, to achieve business value. Members of the enterprise that will implement the business process may be identified and held accountable to deliver the business outcomes.

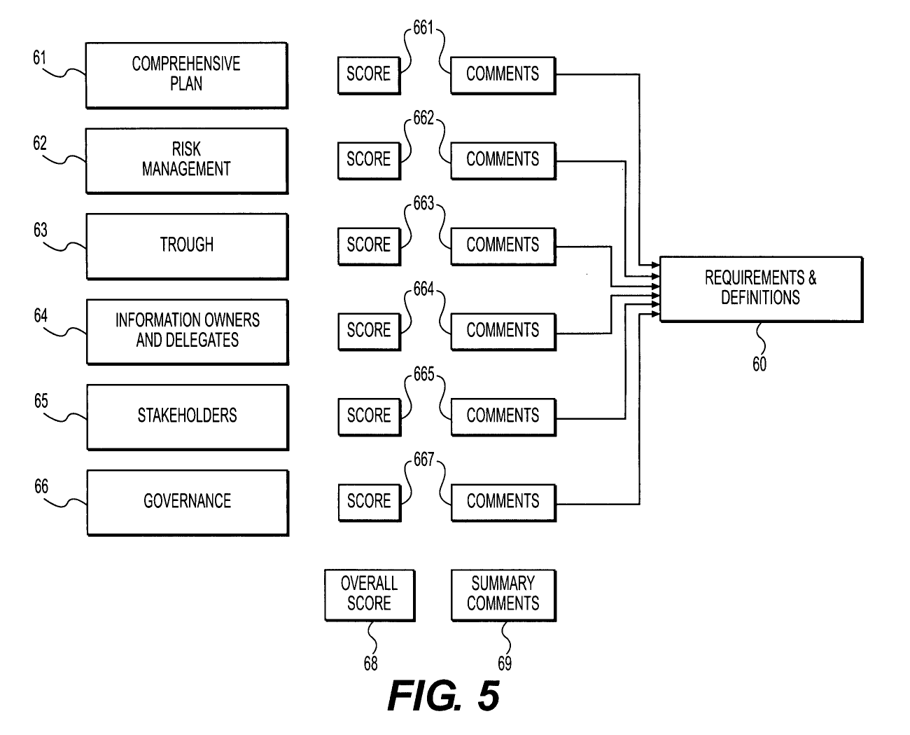

Assessment criterion 60 (Requirements & Definitions) may include supporting criteria 61, 62, 63, 64, 65, and 66, as shown in FIG. 5. Supporting criterion 61 may focus on documenting a comprehensive plan to deliver the desired business value and establish a solid, scalable foundation for the future. The plan may also include clear roles and responsibilities required to realize the projected business value. Supporting criterion 62 may focus on rigorously identifying and managing risk. Risk management may include identifying both risk to the successful delivery of business value as well as risk that the project may pose to the enterprise itself. Supporting criterion 63 may focus on formulating a plan to address a trough situation (i.e., a temporary low point in sales that may result during the project or after implementing the business transformation, but before the business transformation begins to create business value). Supporting criterion 64 may focus on identifying key data that must be shared across the enterprise. Members of the enterprise may be held accountable for providing the key data. Supporting criterion 65 may focus on identifying stakeholders within the enterprise who may agree to deliver the desired business outcomes. Supporting criterion 66 may focus on governance to ensure that clear decision points and accountability is established within the enterprise for decision-making during the creation of the business transformation. Decision rights and accountability may concern project plans and implementation schedules.

Using the data entry forms of computer system 6, users may assign supporting scores and comments 661, 662, 663, 664, 665, and 667 to supporting criteria 61, 62, 63, 64, 65, and 66 respectively, as shown in FIG. 5. Supporting scores and comments 661, 662, 663, 664, 665, and 667 may be based on business judgment and be broadly focused, without excessive detail. Users may also prepare summary comments 69 by pulling key points from supporting scores and comments 661, 662, 663, 664, 665, and 667. Users may present supporting scores and comments 661, 662, 663, 664, 665, and 667 and summary comments 69 to the CIO. The scores may evaluate how well each supporting criterion was performed. The CIO, using business judgment, supporting scores and comments 661, 662, 663, 664, 665, and 667, and summary comments 69, may determine an overall score 68 for how well assessment criterion 60 was performed by the enterprise.

Users of assessment system 10 may use the Requirements & Definitions identified and evaluated in assessment criterion 60 to help determine the IT Applications of assessment criterion 80. Users may identify how assessment criterion 80 (IT Applications) is defined (link 70) by assessment criterion 60 (Requirements & Definitions). Users may determine link 70 by identifying IT Applications that may be implemented to meet the Requirements & Definitions of assessment criterion 60. Users may focus on providing one or more information technology applications that meet the plurality of requirements identified above. Assessment criterion 80 may focus on IT professionals identifying IT Applications that are available at an appropriate time, at an appropriate cost, with an appropriate service level, and from an appropriate source. IT professionals may also ensure that the IT Applications are compatible with the IT architecture used by the enterprise.

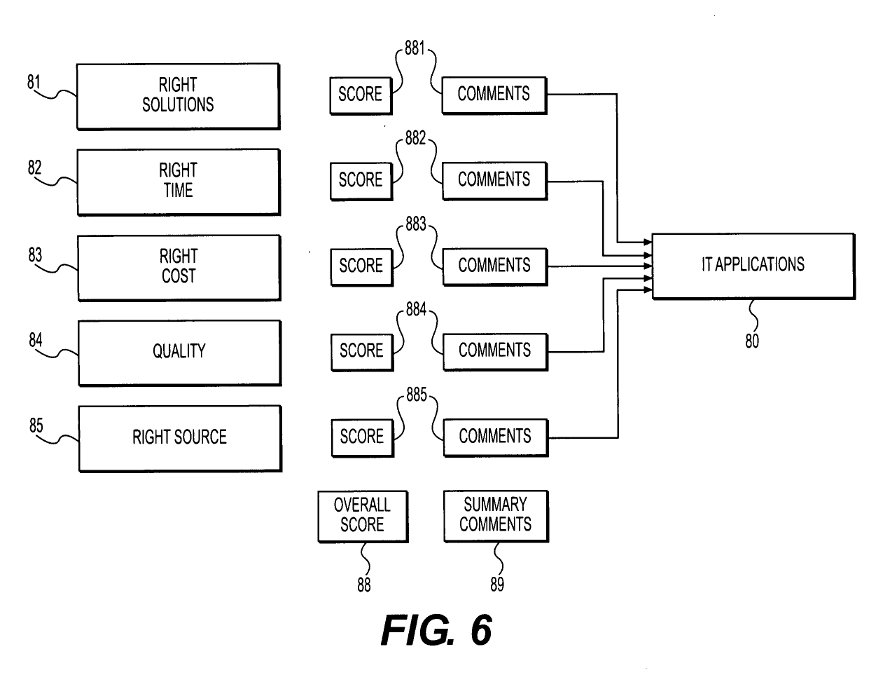

Assessment criterion 80 (IT Applications) may include supporting criteria 81, 82, 83, 84, and 85, as shown in FIG. 6. Supporting criterion 81 may focus on identifying an appropriate solution based on the Requirements & Definitions of assessment criterion 60 and the IT architecture used by the enterprise. Supporting criterion 82 may focus on ensuring that IT applications are delivered and available for use at the required time that was committed to in the requirements and definitions. Supporting criterion 83 may focus on ensuring that IT applications are provided at the agreed cost. Supporting criterion 84 may focus on ensuring that IT applications have sufficient quality to fully meet the requirements and definitions. Users may ensure that the solutions are delivered with the right service level for the business need. Users may also ensure that the solutions are scalable to meet future increases in scale of use. Supporting criterion 85 may focus on ensuring that all aspects (e.g., development, support, and software) of the IT applications are sourced correctly. Users may consider all options, including external software services, and may ensure that the sourcing is consistent with the overall IT sourcing plans of the enterprise.

Using the data entry forms of computer system 6, users may assign supporting scores and comments 881, 882, 883, 884, and 885 to supporting criteria 81, 82, 83, 84, and 85, respectively, as shown in FIG. 6. Supporting scores and comments 881, 882, 883, 884, and 885 may be based on business judgment and be broadly focused, without excessive detail. Users may also prepare summary comments 89 by pulling key points from supporting scores and comments 881, 882, 883, 884, and 885. Users may present supporting scores and comments 881, 882, 883, 884, and 885 and summary comments 89 to the CIO. The scores may evaluate how well each supporting criterion was performed. The CIO, using business judgment, supporting scores and comments 881, 882, 883, 884, and 885, and summary comments 89, may determine an overall score 88 for how well assessment criterion 80 was performed by the enterprise.

Users of assessment system 10 may use the IT Applications identified and evaluated in assessment criterion 80 to help develop the IT Infrastructure of assessment criterion 100. Users may identify how the IT Applications of assessment criterion 80 run on (link 90) the IT Infrastructure of assessment criterion 100. Users may determine link 90 by ensuring that the IT infrastructure is capable to run the IT applications at an appropriate time, at an appropriate cost, with an appropriate service level, and based on an appropriate source. Users may focus on providing information technology infrastructure for running one or more information technology applications identified above. Assessment criterion 100 may also ensure that the IT Infrastructure is compatible with the enterprise's overall IT architecture.

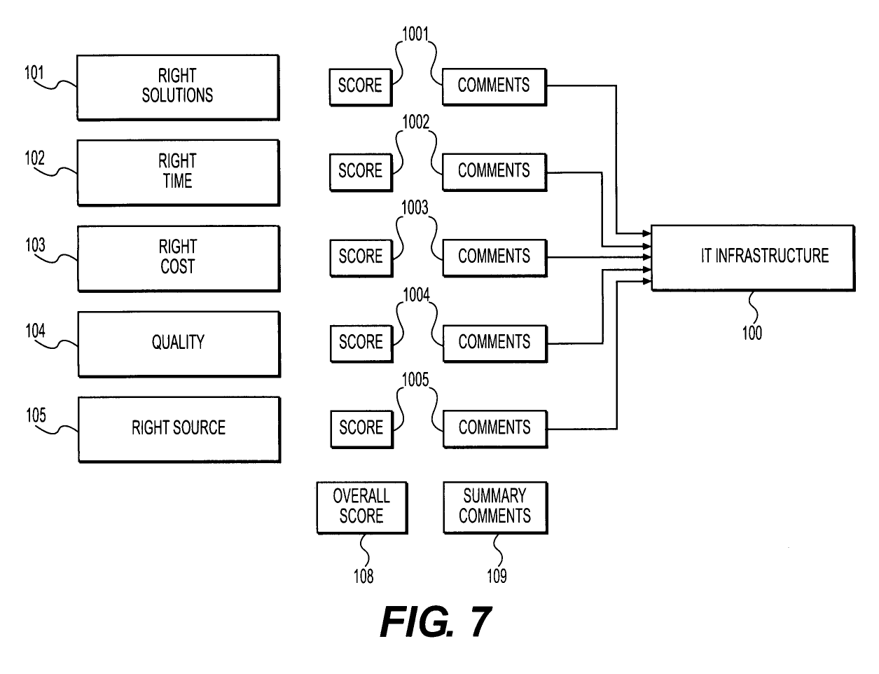

Assessment criterion 100 (IT Infrastructure) may include supporting criteria 101, 102, 103, 104, and 105, as shown in FIG. 7. Supporting criterion 101 may focus on ensuring that the IT infrastructure is the right solution for running the IT applications, based on the Requirements & Definitions of assessment criterion 60 and the enterprise's overall IT architecture. Supporting criterion 102 may focus on ensuring that the IT applications are able to run on the IT infrastructure at an appropriate time, based on the requirements and definitions. Supporting criterion 103 may focus on ensuring that the IT infrastructure is delivered at the agreed cost. Supporting criterion 104 may focus on ensuring that the IT infrastructure is delivered with the right service level for the business need, as identified in the requirements and definitions, and that the solutions are scalable to adjust for future increases in scale of use. Supporting criterion 105 may focus on ensuring that appropriate aspects (e.g., development, support, hardware, and software) of the IT infrastructure are sourced correctly. Users may consider suitable options, including solutions external to the enterprise, and may ensure that the IT infrastructure is consistent with the overall IT sourcing plans of the enterprise.

Using the data entry forms of computer system 6, users may assign supporting scores and comments 1001, 1002, 1003, 1004, and 1005 to supporting criteria 101, 102, 103, 104, and 105, respectively, as shown in FIG. 7. Supporting scores and comments 1001, 1002, 1003, 1004, and 1005 may be based on business judgment and be broadly focused, without excessive detail. Users may also prepare summary comments 109 by pulling key points from supporting scores and comments 1001, 1002, 1003, 1004, and 1005. Users may present supporting scores and comments 1001, 1002, 1003, 1004, and 1005 and summary comments 109 to the CIO. The scores may evaluate how well each supporting criterion was performed. The CIO, using business judgment, supporting scores and comments 1001, 1002, 1003, 1004, and 1005, and summary comments 109, may determine an overall score 108 for how well assessment criterion 100 was performed by the enterprise.

Users of assessment system 10 may use the IT Applications identified and evaluated in assessment criterion 80 to help establish the User/Customer Adoption of assessment criterion 120. Users may identify how assessment criterion 100 (IT Infrastructure) enables (link 110) assessment criterion 120 (User/Customer Adoption). Users may determine link 110 by evaluating whether users and customers actually use the IT Applications of assessment criterion 80 and the IT Infrastructure of assessment criterion 100

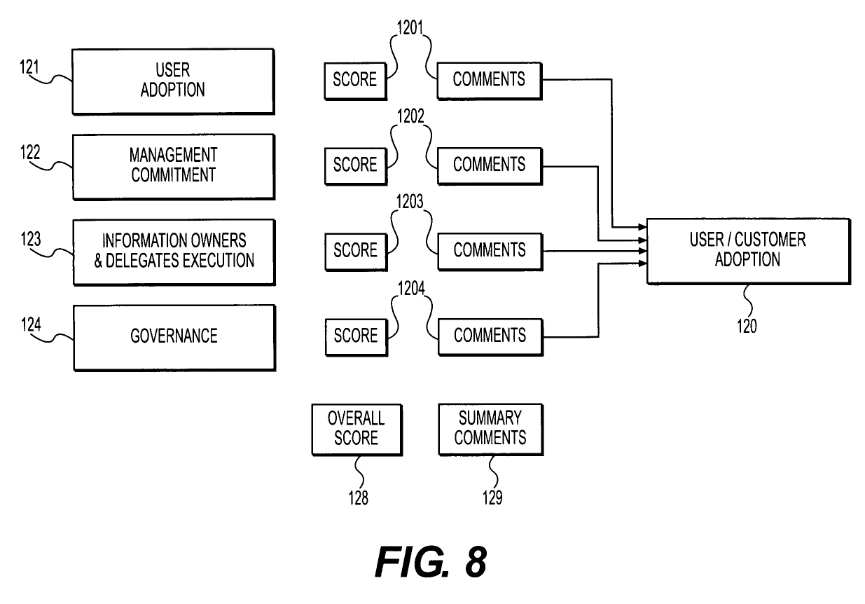

Assessment criterion 120 (User/Customer Adoption) may include supporting criteria 121, 122, 123, and 124, as shown in FIG. 8. Supporting criterion 121 may focus on ensuring that all targeted users across the enterprise are using the new or altered business process as intended. Supporting criterion 122 may focus on ensuring that management across the enterprise integrate the new or altered business process into their work. Users of assessment system 10 may also ensure that managers drive the use of the solution by their organizations. Supporting criterion 123 may focus on ensuring that members of the enterprise, identified to be responsible for key data in supporting criterion 64, consistently provide required information. Supporting criterion 124 may focus on ensuring that decision-making and accountabilities are maintained on an ongoing basis after the business transformation is in place (i.e., governing the ongoing operation of the business process).

Using the data entry forms of computer system 6, users may assign supporting scores and comments 1201, 1202, 1203, and 1204 to supporting criteria 121, 122, 123, and 124, respectively, as shown in FIG. 8. Supporting scores and comments 1201, 1202, 1203, and 1204 may be based on business judgment and be broadly focused, without excessive detail. Users may also prepare summary comments 129 by pulling key points from supporting scores and comments 1201, 1202, 1203, and 1204. Users may present supporting scores and comments 1201, 1202, 1203, and 1204 and summary comments 129 to the CIO. The scores may evaluate how well each supporting criterion was performed. The CIO, using business judgment, supporting scores and comments 1201, 1202, 1203, and 1204, and summary comments 129, may determine an overall score 128 for how well assessment criterion 120 was performed by the enterprise.

Users of assessment system 10 may use the User/Customer Adoption identified and evaluated in assessment criterion 120 to help establish the Business Value of assessment criterion 140. Users may identify how assessment criterion 120 (User/Customer Adoption) delivers (link 130) assessment criterion 140 (Business Value). Users may determine link 130 by evaluating whether the use of the solution by users within the enterprise and by customers actually delivers business value.

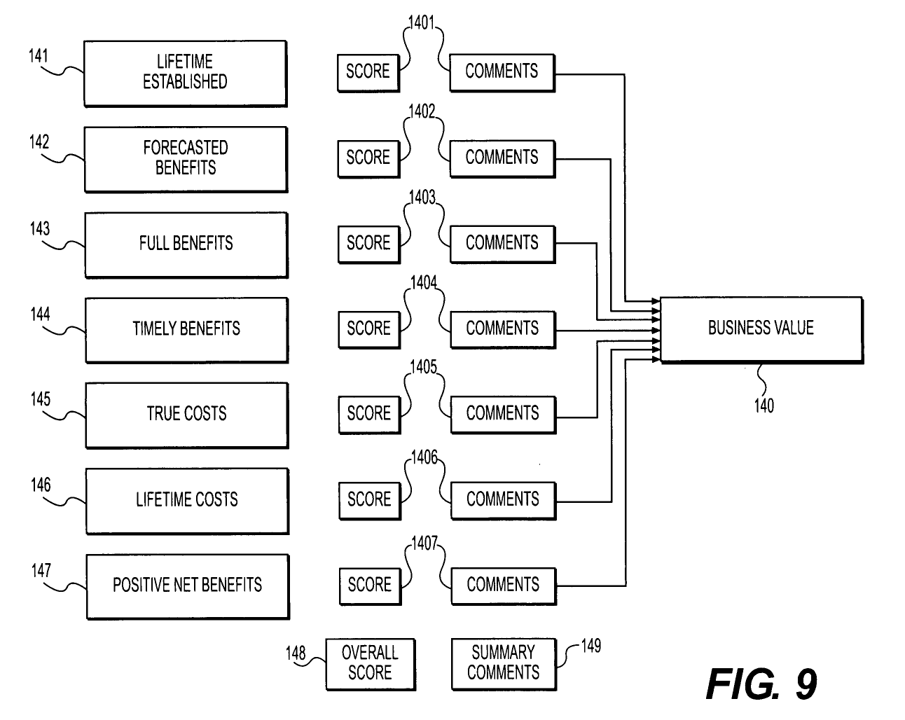

Assessment criterion 140 (Business Value) may include supporting criteria 141, 142, 143, 144, 145, 146, and 147, as shown in FIG. 9. Supporting criterion 141 may focus on establishing and documenting the planned lifetime for the solution. Supporting criterion 142 may focus on forecasting benefits that the solution may bring to the enterprise, justifying the resources expended on the project. Supporting criterion 143 may focus on determining whether full potential benefits of the new or altered business process are realized. Supporting criterion 144 may focus on evaluating whether the benefits are achieved in a timely manner (i.e., achieved as quickly as possible). Supporting criterion 145 may focus on ascertaining the true costs required to implement the solution. In calculating cost, users of assessment system 10 may consider work shifted to other members of the enterprise who are outside the nominal scope of the project. Supporting criterion 146 may focus on determining the lifetime costs of the solution, including operating costs over the planned lifetime. Supporting criterion 147 may focus on determining whether there is a positive net benefit created by the solution. Specifically, users of assessment system 10 may determine whether the benefits of the solution outweigh the costs for the planned lifetime of the solution (including capital and ongoing expenses).

Using the data entry forms of computer system 6, users may assign supporting scores and comments 1401, 1402, 1403, 1404, 1405, 1406, and 1407 to supporting criteria 141, 142, 143, 144, 145, 146, and 147, respectively, as shown in FIG. 9. Supporting scores and comments 1401, 1402, 1403, 1404, 1405, 1406, and 1407 may be based on business judgment and be broadly focused, without excessive detail. Users may also prepare summary comments 149 by pulling key points from supporting scores and comments 1401, 1402, 1403, 1404, 1405, 1406, and 1407. Users may present supporting scores and comments 1401, 1402, 1403, 1404, 1405, 1406, and 1407 and summary comments 149 to the CIO. The scores may evaluate how well each supporting criterion was performed. The CIO, using business judgment, supporting scores and comments 1401, 1402, 1403, 1404, 1405, 1406, and 1407, and summary comments 149, may determine an overall score 148 for how well assessment criterion 140 was performed by the enterprise.

For purposes of illustration, it may be contemplated that a simple exemplary embodiment of a business transformation including an IT component may be changing the business process, including incorporating new software, for sales staff of an enterprise to use in assisting customers who are inquiring about products (i.e., improving the order-to-delivery business process of an enterprise). Assessment system 10 will now be illustrated through this exemplary embodiment. Concerning assessment criterion 20 (Marketplace Needs), users of assessment system 10 may document whether customers may be motivated by receiving accurate information regarding inventory availability during an initial conversation with salespeople. The ability of competing sales staff to immediately provide inventory information may also be evaluated. Concerning supporting criterion 21 (marketplace opportunity), market research may be conducted to determine whether the immediate availability of accurate information will increase sales. Concerning supporting criterion 22 (accountable marketplace expertise), an enterprise may consult with their lead salespeople and sales management to determine whether improved access to a greater amount of information may improve customer satisfaction. Concerning supporting criterion 23 (customer perspective), enterprise personnel may conduct market research by surveying customers about what additional information would be useful for them in making market choices or by conducting passive research by monitoring clicks on an enterprise website to see what information customers are seeking. In addressing assessment criterion 20 (Marketplace Needs), summary comments 29 may include “customers desire immediate information concerning the availability of our new products within a plus/minus one-day accuracy for their location; accurate information regarding the available product color is important to their ultimate decision to purchase.” Overall score 28 may evaluate how well the supporting criteria were performed.

Concerning assessment criterion 40 (Business Process Excellence), users of assessment system 10 may determine that software currently used by their sales staff can only give availability information with a plus/minus 4.5 day accuracy and the software does not account for color (i.e., up to this point sales staff had to use their experience to estimate). Users may also determine that their competitors are delivering 3.0 day accuracy and competing sales staff are also estimating color availability. IT experts within the firm may identify newly available commercial software capable of providing plus/minus 1 day accuracy in product availability and possessing data fields capable of handling color availability. Concerning supporting criterion 41 (strategic intent), users of assessment system 10 may determine that the new software may provide customers with the information they are seeking in making a decision to purchase. Concerning supporting criterion 42 (process design), users may determine that business processes for providing plus/minus one-day accuracy and color information is commercially available. Concerning supporting criterion 43 (global business process owner), the enterprise may designate a single global business process owner to be accountable for the business process and guide the project manager or a project management team having sufficient skill to implement the business transformation. In addressing assessment criterion 40 (Business Process Excellence), the sales example, summary comments 49 may include “commercially available business service is appropriate.” Overall score 48 may evaluate how well the supporting criteria were performed.

Concerning assessment criterion 60 (Requirements & Definitions), users of assessment system 10 may determine the requirements for allowing their sales staff to immediately access accurate information regarding plus/minus 1 day availability per product color and per customer location. Users may consider all members of their enterprise working to provide salespeople with information such as, for example, IT personnel, data entry personnel, manufacturing personnel, warehouse personnel, and shipping personnel. Users may determine the technical requirements necessary to allow their current IT architecture to provide accurate plus/minus one-day availability and color information to salespeople.

Relating to supporting criterion 61 (comprehensive plan), users of assessment system 10 may identify processes that must be performed by IT personnel, data entry personnel, manufacturing personnel, warehouse personnel, and shipping personnel relating to product availability information. Relating to supporting criterion 62 (risk management), users may identify risks to other processes in the enterprise supply chain presented by installing new software and requiring additional information. Users may determine that shipping personnel have limited time resources with which to provide the information, and an additional hire may be necessary to handle the added workload (this may affect cost, discussed below). Additionally, users may determine that some sales may be lost if significant problems arise when salespeople first begin to use the new business process. Concerning supporting criterion 63 (trough), the project manager may identify the possibility that a deep economic downturn may reduce funding for this business transformation initiative before it is complete. Users may provide alternative ways to provide information to customers if the new solution initially falters (e.g., a back-up plan of using last year's numbers to estimate availability). Concerning supporting criterion 64 (information owners and delegates), users of assessment system 10 may designate specific managers in the enterprise's manufacturing plants, warehouses, and shipping facilities to become accountable for the accuracy of the information and to provide the required availability information. Concerning supporting criterion 65 (stakeholders), users may identify sales and operations managers, in addition to the project managers selected in supporting criterion 43, to agree to deliver the desired business outcomes. Concerning supporting criterion 66 (governance), the responsible personnel identified in supporting criterion 65 may be given authority and accountability for making decisions concerning implementation. Addressing assessment criterion 60 (Requirements & Definitions), summary comments 69 may include “Information owners identified in plant, warehouse, and shipping; potential risk in shipping; potential trough situation during implementation.” Overall score 68 may evaluate how well the supporting criteria were performed.

Relating to assessment criterion 80 (IT Applications), users of assessment system 10 may select a software application capable of providing availability and color information for enterprise personnel to use. Concerning supporting criterion 81 (right solutions), users of assessment system 10 may select a software package that will provide enterprise salespeople with availability information. Concerning supporting criterion 82 (right time), users may ensure that the software will be installed within any time constraints set in assessment criterion 60 (e.g., avoiding disruption of current sales service). Concerning supporting criterion 83 (right cost), users may ensure that the software actually costs what it may have been advertised to cost. Concerning supporting criterion 84 (quality), users may ensure that the software performs the functions as advertised. Users may test the software and/or install trial versions of software and have their salespeople test the software. Users may also ensure that the software has capacity to handle increases in sales, numbers of computers, data, and databases. Users may also consider the services and warranties provided by the software provider during and after installation. Concerning supporting criterion 85 (right source), users may determine whether the software fits into the enterprise's current architecture in terms of compatibility. Users may also consider other factors, such as service contracts and warranties that may be affected by implementation. Addressing assessment criterion 80 (IT Applications), summary comments 89 may include “use software X distributed by company Y; meets requirements.” Overall score 88 may evaluate how well the supporting criteria were performed.

Relating to assessment criterion 100 (IT Infrastructure), users of assessment system 10 may evaluate how the IT Infrastructure may support the sales application. Concerning supporting criterion 101 (right solutions), users of assessment system 10 may determine whether the current IT infrastructure of the firm is able to run the new software, and whether the software is compatible with the existing enterprise architecture. Concerning supporting criterion 102 (right time), users may ensure that the software can be completely installed in a timely manner and no unnecessary downtime is required (i.e., lost sales). Concerning supporting criterion 103 (right cost), users may ensure that the appropriate software and services are provided, and that the enterprise absorbs no service costs that the software provider was paid to provide. Concerning supporting criterion 104 (quality), users may ensure that the software is installed properly and completely across all applicable enterprise IT systems. Users may also ensure that the software has the capacity to handle additional data, computers, and business locations. Concerning supporting criterion 105 (right source), users may ensure that the software is installed across the enterprise's IT architecture by competent IT personnel and with outsourced IT personnel as required. Relating to assessment criterion 100 (IT Infrastructure), summary comments 109 may include “IT infrastructure adequate; some additional sourcing necessary.” Overall score 108 may evaluate how well the supporting criteria were performed.

Relating to assessment criterion 120 (User/Customer Adoption), users of assessment system 10 may evaluate how sales staff and customers may use the contemplated business transformation. Concerning supporting criterion 121 (user adoption), users of assessment system 10 may survey and observe both salespeople within the enterprise and their customers to determine whether customers are requesting availability and color information and whether salespeople are providing the information. Concerning supporting criterion 122 (management commitment), users may ensure that managers of the enterprise's manufacturing plants, warehouses, shipping facilities, and sales offices are directing their staffs to use the new IT components to provide the desired information to the customer. Concerning supporting criterion 123 (information owners), users may ensure that information providers in the enterprise's manufacturing plants, warehouses, shipping facilities, and sales offices are providing the desired information to their customers. Concerning supporting criterion 124, users may ensure that enterprise managers make appropriate decisions so that the availability information reaches the customers. Relating to assessment criterion 120 (User/Customer Adoption), summary comments 129 may include “customers and sales force using new process; some problems with information flow in shipping.” Overall score 128 may evaluate how well the supporting criteria were performed.

Relating to assessment criterion 140 (Business Value), users may evaluate how the new sales process produces business value. Concerning supporting criterion 141 (lifetime), users of assessment system 10 may establish that the planned lifetime for the solution is 2-4 years, based on the pace of IT development. Concerning supporting criterion 142 (forecasted benefits), users may estimate an increase in sales of 8%. Concerning supporting criterion 143 (full benefits), users may determine whether additional types of data could be incorporated into the new business process to increase purchases by customers. Concerning supporting criterion 144 (timely benefits), users may determine that after a slight dip in sales during and immediately following implementation, sales increased after two weeks. Concerning supporting criterion 145 (true costs), users may determine that costs include the price of software, outside consulting to help in installation and early use, and hiring an additional employee to help with information in shipping. Concerning supporting criterion 146 (lifetime costs), users may determine that the cost of an additional employee in shipping and the cost of a service contract for the software comprise the lifetime costs. Concerning supporting criterion 147, users may determine that the benefits of supporting criterion 144 exceed the costs of supporting criteria 145 and 146, resulting in a positive net benefit. Relating to assessment criterion 140 (Business Value), summary comments 149 may include “Increased sales; net positive benefit.” Overall score 148 may evaluate how well the supporting criteria were performed.

### INDUSTRIAL APPLICABILITY

The disclosed assessment system may help to implement a business transformation having an IT component. The assessment system may allow senior managers of an enterprise to assess whether a business transformation having an IT component will create business value and should be implemented. The assessment system may also allow senior managers to determine if there may be lessons to be learned from past business transformations.

After considering the criteria described above, users of assessment system 10 may present the criteria to senior managers of the enterprise such as, for example, the CIO. Users may utilize computer system 6 in presenting the information to the CIO. Users may use printers, displays, projectors, or other suitable output devices associated with I/O device 16 to present the criteria to the CIO. The CIO may review supporting criteria, scores, and comments for criteria 20, 40, 60, 80, 100, 120, and 140.

Based on the criteria, scores, and comments, the CIO may make a decision as to whether to make a contemplated business transformation, whether a current business transformation should be maintained, or whether there may be lessons to be learned from a past business transformation. The CIO may also direct changes to be made within the enterprise to facilitate the business transformation, based on the presented information.

Users of assessment system 10 may also present criteria of ongoing or past business transformations to the CIO. Based on the presented criteria, the CIO may decide to make changes or to stop an ongoing transformation to maximize business value. The CIO may also identify lessons learned from past business transformations to help in planning future projects.

Assessment system 10 may help to implement a business transformation having an IT component. Assessment system 10 may allow a senior manager such as, for example, a CIO, to assess whether a business transformation having an IT component will create business value and should be implemented. The CIO may use assessment system 10 to facilitate considering the contemplated business transformation within the context of the operations of an entire enterprise, allowing the CIO to decide whether the contemplated business transformation should be made or whether there are lessons to be learned from a past business transformation. In doing so, the enterprise may avoid wasting resources on ill-conceived business transformations that will likely create no business value.

It will be apparent to those skilled in the art that various modifications and variations can be made to the disclosed system and method without departing from the scope of the disclosure. Additionally, other embodiments of the disclosed system and method will be apparent to those skilled in the art from consideration of the specification. It is intended that the specification and examples be considered as exemplary only, with a true scope of the disclosure being indicated by the following claims and their equivalents.

What is claimed is:

1. A method for assessing a business transformation, comprising:
identifying a marketplace need for the business transformation;
determining a business process to meet the marketplace need;
determining a plurality of requirements to execute the business process;
identifying one or more information technology applications to meet the plurality of requirements;
determining an information technology infrastructure for running the one or more information technology applications;
determining an extent of use of the business process by information technology users and customers;
determining business value created by the business process; and
evaluating the determinations using a plurality of computer data forms.

2. The method of claim 1, wherein identifying the marketplace need includes identifying indications of marketplace opportunity, applying marketplace expertise, and identifying end customer value drivers.

3. The method of claim 1, wherein determining the business process includes documenting competitive differentiation, selecting a business process design, and identifying at least one global business process owner.

4. The method of claim 1, wherein determining the plurality of requirements includes documenting a business and project plan, identifying risk, addressing a trough situation, identifying key data and information owners, identifying stakeholders, and establishing decision rights with accountability.

5. The method of claim 1, wherein identifying one or more information technology applications includes identifying an appropriate solution, ensuring appropriate delivery, ensuring appropriate cost, ensuring appropriate quality, and ensuring appropriate sourcing.

6. The method of claim 1, wherein determining the information technology infrastructure includes identifying an appropriate solution, ensuring appropriate delivery, ensuring appropriate cost, ensuring appropriate quality, and ensuring appropriate sourcing.

7. The method of claim 1, wherein determining the extent of use includes ensuring that targeted users use the business process, ensuring that management integrates the business process, ensuring that responsible information owners manage and share key data, and ensuring appropriate decision-making with accountability.

8. The method of claim 1, wherein determining business value includes establishing a planned lifetime, achieving forecasted benefits, determining achievement of potential benefits, evaluating timeliness of benefits, ascertaining true costs, determining lifetime costs, and determining a positive net benefit.

9. The method of claim 8, wherein the positive net benefit is determined by comparing benefits to true costs and lifetime costs.

10. The method of claim 9, further including making a business decision to make the business transformation, change the business transformation, or identify lessons learned from the business transformation, wherein the business transformation is a past, present, or future business transformation.

11. A system for assessing a business transformation containing an information technology component, comprising:
an input device for receiving input associated with an assessment;
an output device for providing assessment data to a user; and
a storage device configured to:
store a score relating to identifying a marketplace need;
store a score relating to determining a business process to meet the marketplace need;
store a score relating to determining a plurality of requirements to execute the business process;
store a score relating to identifying one or more information technology applications to meet the plurality of requirements;
store a score relating to determining an information technology infrastructure for running the one or more information technology applications;
store a score relating to determining an extent of use of the business process by information technology users and customers; and
store a score relating to determining business value created by the business process.

12. The system of claim 11, wherein the system includes a plurality of data entry forms for receiving the scores to evaluate the business transformation.

13. A method for evaluating a completed business transformation, comprising:
determining a score associated with identifying a marketplace need for the business transformation;
determining a score associated with determining a business process that met the marketplace need;
determining a score associated with determining a plurality of requirements that met the marketplace need;
determining a score associated with identifying one or more information technology applications that met the plurality of requirements;
determining a score associated with determining an information technology infrastructure that ran the one or more information technology applications;
determining a score associated with determining an extent of use of the business process by information technology users and customers;
determining a score associated with determining a business value that was created by the business transformation; and
recording evaluations using a plurality of computer data forms.

14. The method of claim 13, wherein determining a score associated with identifying the marketplace need includes evaluating how well identifying proof of marketplace opportunity, applying marketplace expertise, and identifying end customer value drivers were performed.

15. The method of claim 13, wherein determining a score associated with determining the business process that met the marketplace need includes evaluating how well documenting competitive differentiation, selecting a business process design, and identifying at least one global business process owner were performed.

16. The method of claim 13, wherein determining a score associated with determining the plurality of requirements that met the marketplace need includes evaluating how well documenting a business and project plan, identifying risk, addressing a trough situation, identifying key data and information owners, identifying stakeholders, and establishing decision rights with accountability were performed.

17. The method of claim 13, wherein determining a score associated with identifying one or more information technology applications that met the plurality of requirements includes evaluating how well identifying an appropriate solution, ensuring appropriate delivery, ensuring appropriate cost, ensuring appropriate quality, and ensuring appropriate sourcing were performed.

18. The method of claim 13, wherein determining a score associated with determining the information technology infrastructure that ran the one or more information technology applications includes evaluating how well identifying an appropriate solution, ensuring appropriate delivery, ensuring appropriate cost, ensuring appropriate quality, and ensuring appropriate sourcing were performed.

19. The method of claim 13, wherein determining a score associated with determining the extent of use of the business process by information technology users and customers includes evaluating how well ensuring that targeted users use the business process, ensuring that management integrates the business process, ensuring that responsible information owners manage and share key data, and ensuring appropriate decision-making with accountability were performed.

20. The method of claim 13, wherein determining a score associated with determining the business value that was created by the business transformation includes evaluating how well establishing a planned lifetime, achieving forecasted benefits, determining achievement of potential benefits, evaluating timeliness of benefits, ascertaining true costs, determining lifetime costs, and determining a positive net benefit were performed.
